(19) United States
(12) Patent Application Publication
(10) Pub. No.: US 2016/0159290 A1
(43) Pub. Date: Jun. 9, 2016

(54) COLLAPSIBLE RACK SYSTEM FOR A PICK UP TRUCK

(71) Applicants: Artin Tamaddon-Dallal, Foothill Ranch, CA (US); Saied Tamaddon, Foothill Ranch, CA (US)

(72) Inventors: Artin Tamaddon-Dallal, Foothill Ranch, CA (US); Saied Tamaddon, Foothill Ranch, CA (US)

(21) Appl. No.: 14/561,611

(22) Filed: Dec. 5, 2014

(51) Int. Cl. B60R 9/045

(52) U.S. Cl. CPC B60R 9/045

(57) ABSTRACT

A collapsible rack system for supporting material on a vehicle may include one or more support elements fixedly positioned above a roof of the vehicle and a plurality of slidable racks connected with the one or more support elements. The slidable racks may be positionable above the roof of the vehicle or above an un-roofed portion of the vehicle while remaining connected with the one or more support elements.

### BACKGROUND OF THE INVENTION

The present invention relates to racks that provide support above a bed of a pick-up truck, and more particularly, to racks which can be readily placed or removed from a position above the bed of the pick-up truck.

A typical pick-up truck may be used to carry various types of materials. Some materials may fit entirely within a bed of the truck while other materials, e.g., lumber or ladders may have lengths greater than the inside dimensions of the bed. When a truck is used to routinely carry such long-length loads, the truck may be modified by installation of a permanent over-the-bed rack.

While installation of a permanent over-the-bed rack may provide load carrying advantages for long-length loads, such a rack may diminish overall load carrying flexibility of the truck. For example, a permanently installed rack may preclude use of the truck to carry tall items such as a refrigerator or piece of furniture because such items may not fit under the permanently installed rack.

Occasionally, a truck may be used to carry loose light-weight material which may be subject to being blown out of the bed when the truck is driven along a road. In that case, a tarp is often placed over the loose material and secured to the bed of the truck. A typical pick-up truck does not have convenient tarp-securing hardware in its bed. Nor does it have space for convenient tarp storage.

As can be seen, there is a need for a system that may incorporate both a long-length material carrying capability and a convenient tarp support into a pick-up truck. More particularly, there is a need for such a system that will not diminish flexibility of cargo carrying capability of the truck.

### SUMMARY OF THE INVENTION

In one aspect of the present invention, a system for supporting material on a vehicle may comprise: a support element; and at least a first and a second slidable rack interconnected with the support element; wherein the slidable racks are positionable above a roof of the vehicle in a collapsed configuration or above a un-roofed portion of the vehicle in an extended configuration while remaining interconnected with the support element.

In another aspect of the present invention, a collapsible rack system for a pick-up truck may comprise: a first slidable rack having a first slide element configured to be oriented parallel to a longitudinal axis of the truck; and a second slidable rack having a second slide element configured to be oriented parallel to the longitudinal axis of the truck; wherein the first slide element and the second slide element are configured to be interconnected to one another by a T-groove and T-bar slidable connection.

In still another aspect of the present invention, a tarp support system for a pick-up truck may comprise: a collapsible rack configured to overlie a roof of the truck when in a collapsed configuration and to overlie a bed of the truck when in an extended tarp-supporting position; wherein the rack is configured to be displaced from a roof of the truck so that a tarp storage pocket is present between the rack and the roof of the truck.

These and other features, aspects and advantages of the present invention will become better understood with reference to the following drawings, description and claims.

### BRIEF DESCRIPTION OF THE DRAWINGS

FIG. 1 is a perspective view of a material support system for a vehicle in accordance with an exemplary embodiment of the invention;

FIG. 2 is a perspective view of the system of FIG. 1 in a second operational configuration in accordance with an exemplary embodiment of the invention;

FIG. 3 is a perspective exploded view of a portion of the system of FIG. 1 in accordance with an exemplary embodiment of the invention;

FIG. 4 is a schematic cross-sectional view of a portion of the system of FIG. 1 taken along the lines 4-4 of FIG. 3 in accordance with an exemplary embodiment of the invention;

FIG. 5 is a perspective exploded view of portions of the system of FIG. 1 showing a collapsible feature in accordance with an exemplary embodiment of the invention;

FIG. 6 is a perspective exploded view of support legs of the system of FIG. 1 in accordance with an exemplary embodiment of the invention;

FIG. 6a is a detailed elevation view of a portion of a support leg of FIG. 6 in accordance with an exemplary embodiment of the invention;

FIG. 7 is an exploded perspective view of an attachment feature for the support legs of FIG. 6 in accordance with an exemplary embodiment of the invention; and

FIG. 8 is a perspective view of a material support system for a vehicle in accordance with a second exemplary embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

The present invention generally provides a collapsible rack system for a pick-up truck which may be extended from a position over a roof of the truck into a position over the bed when needed and retracted from the bed to overlie a roof of the truck when not in use.

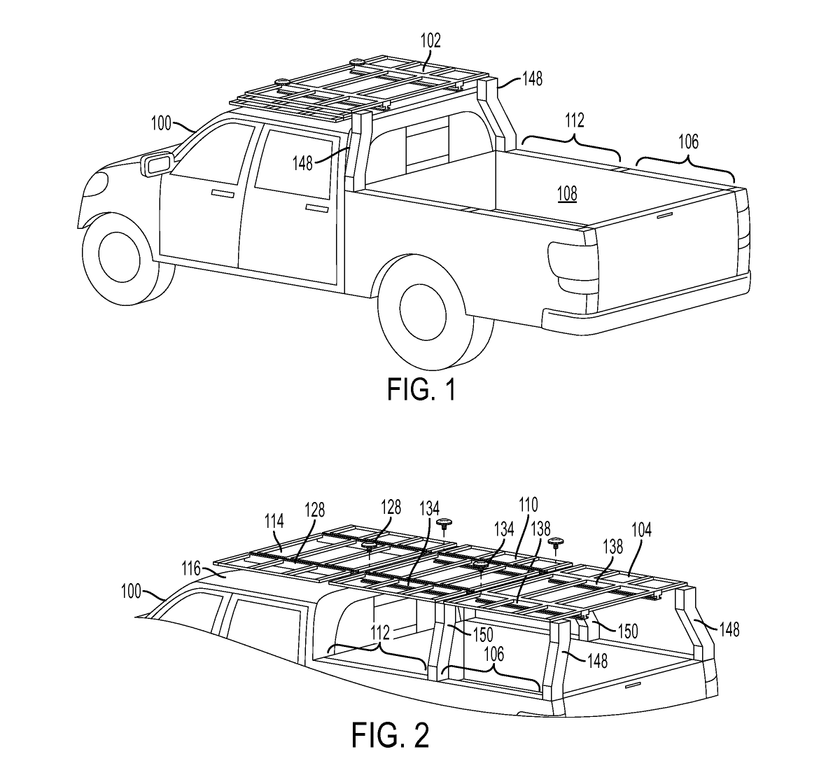

Turning now to the description and with reference first to FIGS. 1 and 2, a vehicle such as a pick-up truck 100 may be equipped with an exemplary embodiment of a material support system 102. In general, the material support system 102 may include two or more slidable racks connected with the one or more support elements. The slidable racks may be positionable above the roof of the vehicle or above an un-roofed portion of the vehicle while remaining connected with the one or more support elements.

More specifically, the material support system 102 may be considered to be a collapsible rack system. In an exemplary embodiment of the system 102, a top rack 104 may be positionable over a rear portion 106 of an open bed 108 of the truck 100 as shown in FIG. 2. An intermediate rack 110 may be positionable over a mid-portion 112 of the bed 108. A fixed rack 114 may be positionable to remain above a roof 116 of the truck 100.

The system 102 may be particularly advantageous when installed on a pick-up truck having a roof length shorter than a bed length. The multiple slidable racks may be collapsed over one another to fit over a short roof of the truck. The multiple slidable racks may be extended to a length that may be equal to the length of a long bed of the truck so that the entire long bed of the truck may be covered with slidable racks. In that regard, it should be noted the system 102 is not to be considered to be limited to only two slidable racks. Any number of slidable racks may be employed to achieve a desired capability of storage above a roof of a truck and full coverage of a bed of a truck. For example a truck may have a roof length of about 2 feet and a bed length of about 8 feet. In that case it may be advantageous to include four slidable racks in the system 102.

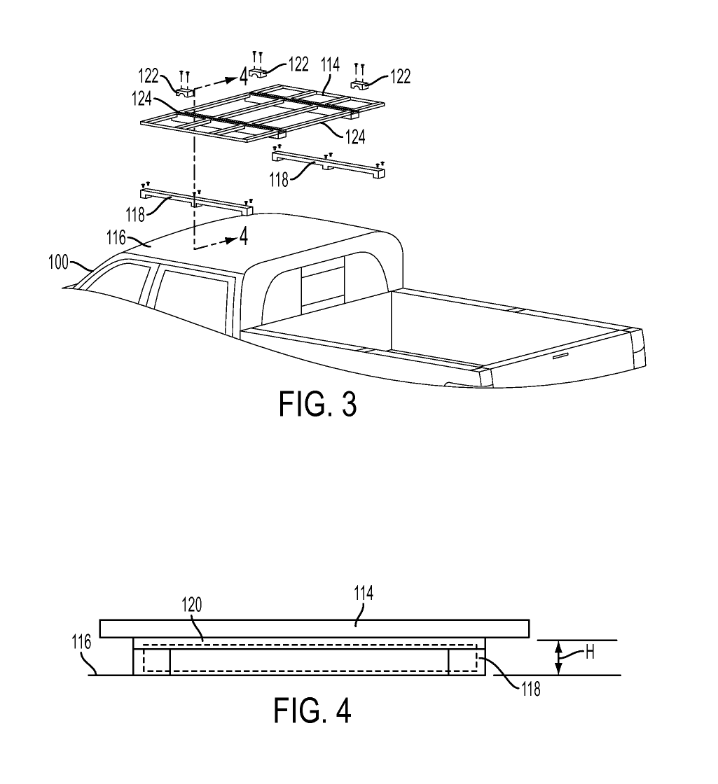

In an exemplary embodiment shown in FIGS. 3 and 4, the fixed rack 114 may be attached to support elements or base brackets 118. The base brackets 118 may have a height H large enough to accommodate storage of a folded tarp 120 in a space between the roof 116 and the fixed rack 114.

Some models of trucks may be provided with roof brackets (not shown) which are installed as a so-called factory option. On such factory-equipped trucks, mounting holes may be present in the roof. These pre-existing mounting holes may be advantageously employed for mounting the base brackets 118. The fixed rack 114 may be attached to the base brackets 118 with clamping devices 122 that may surround a top portion of a lateral member 124 of the fixed rack 114. The clamping devices 122 may be held in place with threaded fasteners secured within threaded holes in the base brackets 118. Thus, in such an exemplary embodiment, the fixed rack 114 may be installed without a need to drill any additional holes in the roof 116 of the truck 100.

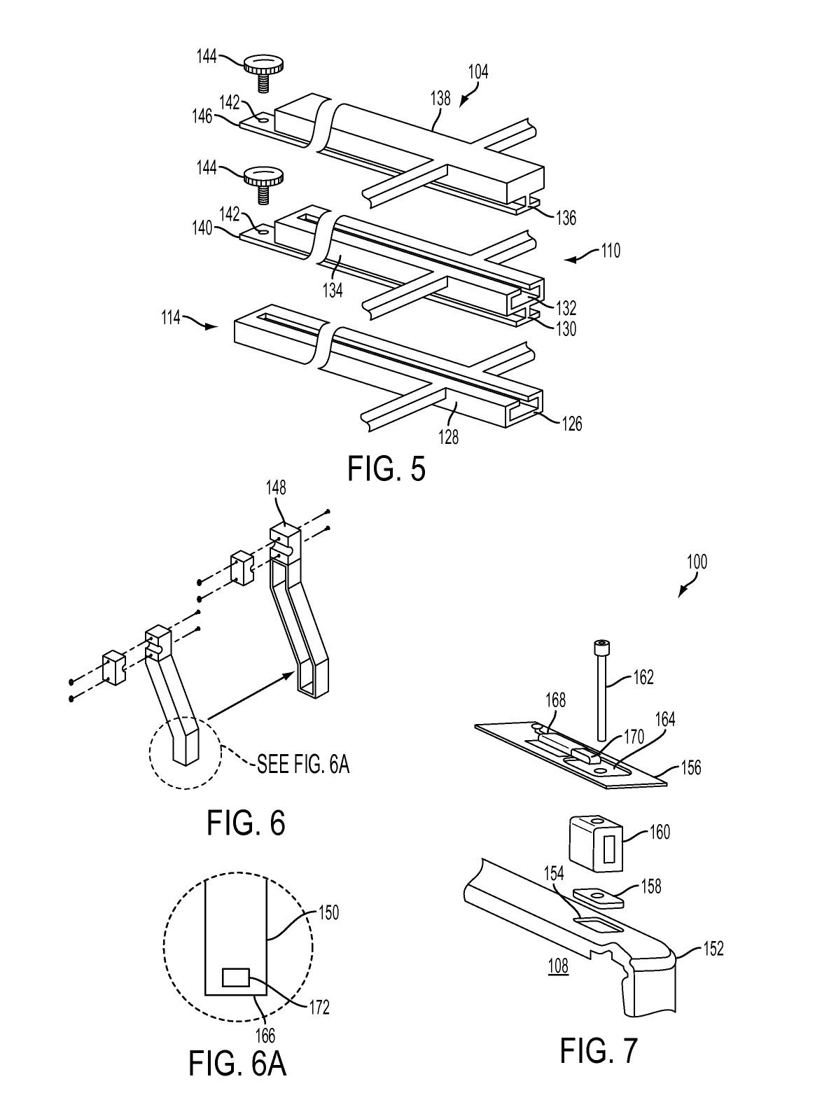

Referring now to FIG. 5, it may be seen that in an exemplary embodiment, the top rack 104, the intermediate rack 110 and the fixed rack 114 may be slidably engaged with one another through employment of slide elements such as T-groove and T-bar slidable connections. For example, the fixed rack 114 may have a T-groove 126 formed in a longitudinal member 128 (i.e., a member oriented parallel to a longitudinal axis of the truck). The longitudinal members 128 may function as support elements for the intermediate rack 110. The intermediate rack 110 may be provided with a T-bar 130 and a T-groove 132 formed on a longitudinal member 134. The top rack 104 may be provided with a T-bar 136 formed on a longitudinal member 138.

The T-bar 130 may be provided with a flat extension 140 with a threaded hole 142 therein. After the racks 110 and 114 are in a desired position relative to one another, a threaded twist knob 144 may be screwed down through the hole 142 to produce pressure on a bottom of the underlying T-groove 126 thereby locking the racks into their desired relative positions. Similarly, the top rack 104 may be locked into position relative to the intermediate rack 110 by tightening one of the threaded twist knobs 144 within a flat extension 146 of the T-bar 136.

Referring back to FIG. 2, it may be seen that support legs may be provided to support one or more of the racks. In particular, FIG. 2 illustrates support legs 148 which may be employed to support a free end of the top rack 104, and support legs 150 which may provide support for the intermediate rack 110 and the top rack 104. Referring more particularly to FIG. 6, it may be seen that in an exemplary embodiment, the support legs 148 may be formed as hollow structures with an open side. The support legs 150 may have a shape similar to, but smaller than, the support legs 148. Thus the support legs 150 may compactly nest inside the support legs 148 when the top rack 104 and the intermediate rack 110 are collapsed together over the roof 116 of the truck 100.

Referring now to FIGS. 6a and 7, there is illustrated an exemplary embodiment of a system for securing the support legs 148 and 150 to a side wall or bed rail 152 of the truck 100. Many models of pick-up trucks are provided with stake pockets 154 in the bed rails 152. The stake pockets 154 may be advantageously employed for securing the support legs 148 and 150 in position when the top rail 104 and the intermediate rack 110 are extended into position over the bed 108 of the truck 100. Latching plates 156 may be positioned over the stake pockets 154 and held in place with pocket nuts 158, expansion blocks 160 and screws 162. The latching plates 156 may be provided with recesses 164 for accommodating bottoms 166 of the support legs 148 and 150. Spring loaded latches 168 may be attached to the latching plates 156. Keepers 170 of the latches 168 may engage holes 172 in the support legs 148 and 150 to hold the support legs in position within the recesses 164.

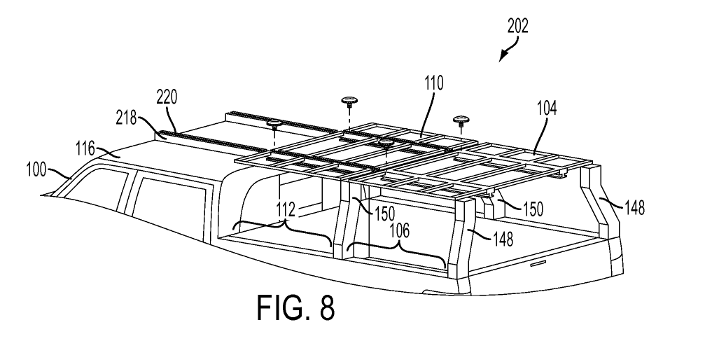

Referring now to FIG. 8, an alternative exemplary embodiment of a collapsible rack system 202 is shown. The system 202 shown in FIG. 8 may include only two material support racks, the intermediate rack 110 and the top rack 104. Base brackets 218 may be provided with T-grooves 220 and may be positioned on the roof 116 of the truck 100 in alignment with the longitudinal members 134 (See FIG. 5) of the intermediate rack 110. The base brackets 218 may function as support elements for the rack 110. The rack 110 may slidably engage with the base brackets 218 and the rack 104 may slidably engage with the rack 110. Thus, the rack system 202 may function as a collapsible racks system without a need for a fixed rack attached to the roof 116 of the truck 100.

It should be understood, of course, that the foregoing relates to exemplary embodiments of the invention and that modifications may be made without departing from the spirit and scope of the invention as set forth in the following claims.

We claim:

1. A system for supporting material on a vehicle comprising:
a support element; and
at least a first and a second slidable rack interconnected with the support element;
wherein the slidable racks are positionable above a roof of the vehicle in a collapsed configuration or above a un-roofed portion of the vehicle in an extended configuration while remaining interconnected with the support element.

2. The system of claim 1 wherein the slidable racks are provided with support legs.

3. The system of claim 2:
wherein the second slidable rack is positionable above the first slidable rack; and
wherein the support legs of the first slidable rack are configured to nest within the support legs of the second slidable rack when the slidable racks are in the collapsed configuration.

4. The system of claim 2 wherein the support legs are positioned to engage with side walls of the un-roofed portion of the vehicle when the slidable racks are in the extended configuration.

5. The system of claim 3 wherein the support legs are positioned to engage with pockets in the side walls.

6. The system of claim 1 wherein the slidable racks are interconnected to one another by T-groove and T-bar slidable connections.

7. The system of claim 1 further comprising a fixed rack interposed between the support elements and the slidable racks.

8. The system of claim 1 wherein the support elements are portions of a fixed rack.

9. A collapsible rack system for a pick-up truck comprising:
a first slidable rack having a first slide element configured to be oriented parallel to a longitudinal axis of the truck; and
a second slidable rack having a second slide element configured to be oriented parallel to the longitudinal axis of the truck;
wherein the first slide element and the second slide element are configured to be interconnected to one another by a T-groove and T-bar slidable connection.

10. The collapsible rack system of claim 9:
wherein the first slidable rack is configured to be positioned higher than a roof of the truck;
wherein the second slidable rack is configured to be positioned higher than the first slidable rack; and
wherein the second slidable rack is provided with support legs which are configured to extend from the second slidable rack to side walls of a bed of the truck when the second slidable rack overlies the bed of the truck.

11. The collapsible rack system of claim 9 further comprising:
a third rack having third slide elements configured to be oriented parallel to the longitudinal axis of the truck.
the first slide elements and the third slide elements are configured to be interconnected to one another by a T-groove and T-bar slidable connection.

12. The collapsible rack system of claim 11 wherein the third rack is configured to be fixedly positioned above a roof of the truck.

13. The collapsible rack system of claim 11 wherein support legs of the first slidable rack nest inside support legs of the second slidable rack when the first and the second slidable racks overlie a roof of the truck.

14. The collapsible rack system of claim 11 wherein the support legs are positionable over side rail pockets of the truck.

15. The collapsible rack system of claim 14 further comprising:
latching assemblies configured to be positioned at the side rail pockets of the truck, wherein the latching assemblies include:
a latching plate;
a recess formed in the latching plate with a shape that conforms to a cross-section shape of the support legs; and
a spring loaded latch with a keeper configured to extend into a position overlying the recess,
wherein the support legs are provided with openings configured to engage with the keeper of the spring loaded latch.

16. The collapsible rack system of claim 15 wherein the base plate is securable within the pocket with a pocket nut, an expansion block and a screw.

17. The collapsible rack system of claim 9:
wherein T-groove and T-bar slidable connections are configured so that a T-bar overlies a T-groove;
the T-bar is provided with a flat extension with a threaded hole;
a clamping screw passes through the flat extension and is configured to clamp against a bottom of an underlying one of the T-grooves to lock adjacent ones of the racks into desired longitudinal positions.

18. A tarp support system for a pick-up truck comprising:
a collapsible rack configured to overlie a roof of the truck when in a collapsed configuration and to overlie a bed of the truck when in an extended tarp-supporting position;
wherein the rack is configured to be displaced from a roof of the truck so that a tarp storage pocket is present between the rack and the roof of the truck.

19. The tarp support system of claim 18:
wherein first and second slidable racks have slide elements configured to be oriented parallel to a longitudinal axis of the truck;
wherein the slide elements are configured to be interconnected to one another by T-groove and T-bar slidable connections.

20. The tarp support system of claim 19 further comprising:
support legs attached to the slidable racks;
wherein the support legs of the first slidable rack nest within the support legs of the second slidable rack when the slidable racks are in the collapsed configuration.
